(19) United States
(12) Patent Application Publication
(10) Pub. No.: US 2005/0147790 A1
(43) Pub. Date: Jul. 7, 2005

(54) Method for making a soundproofing panel with at least one double resonator

(75) Inventor: Jean-Luc J L L Levavasseur, Le Harve (FR)

Correspondence Address: OLIFF & BERRIDGE, PLC, P.O. BOX 19928, ALEXANDRIA, VA, 22320, US

(73) Assignee: HUREL HISPANO, Gonfreville L' Orcher (FR)

(21) Appl. No.: 10/517,991

(22) PCT Filed: Jun. 17, 2003
(86) PCT No.: PCT/FR03/01824

(30) Foreign Application Priority Data
Jun. 17, 2002 (FR) 02/07416

(51) Int. Cl. B32B 3/12; B32B 3/10

(52) U.S. Cl. 428/116; 428/137

(57) ABSTRACT

The invention concerns a method for making a soundproofing panel with at least one double resonator used for example on pods enclosing aircraft turbojets. Said method is characterized in that the septum is formed by assembling a plurality of parts against one of the honeycomb cores, said parts being cut out in foil, said parts being defined to enable the shape of the septum to be more or less adapted to extensible surfaces, said parts enabling significant reduction of the cost for perforating the septum.

### TECHNICAL FIELD OF THE INVENTION

The invention relates to acoustic panels used for example on pods and reversers of aircraft propelled by turbojets of the turbofan type and more specifically to an economic and reliable method for making panels with at least a double resonator, namely panels with a double resonator, a triple resonator etc.

### PRIOR ART AND PROBLEM PRESENTED

Pods surrounding bypass turbojets, also called “turbofans”, form an annular conduit around the turbojet called a “secondary vein” or “vein” of which the walls in contact with the secondary flow consist of acoustic panels so as to ensure at the same time rigidity of the pod, channelling of air passing through the pod and absorption of noise generated mainly by the blower. The vein has a substantially circular general shape axisymmetric about the turbojet and more specifically about its geometric axis, but its cross section varies continuously from the front to the rear of the pod so as to achieve an optimum compromise between the flow constraints of the secondary flow and those of the overall size of the pod. The panels to be made have consequently rounded shapes matching the shell sectors. The term “rounded” is understood to mean that the panels have a non-developable curved surface, that is to say that it cannot be developed on a plane without tearing or duplication.

Acoustic panels are well known in aeronautics. They are sandwich structures having, in the thickness direction, a plurality of layers assembled together.

Conventionally, panels called “single resonator” panels are used comprising three layers, namely an “acoustic” multiperforated skin, a honeycomb and a solid skin. The layers are assembled together by adhesive bonding. The acoustic skin and the solid skin are for example made of an organic composite material comprising 3 to 10 reinforcing fabric layers embedded in a resin hardened by curing. The acoustic skin and the solid skin are made separately by molding to the final shape of the panel according to well-known techniques. The acoustic skin is then drilled and the assembly of solid skin+honeycomb+acoustic skin is assembled by hot bonding under pressure in an autoclave so as to ensure the best possible contact between the three layers. In a variant of the method, during assembly, the solid skin can be directly made and molded onto the honeycomb that it covers. It will be understood that the skins kept apart by the honeycomb provide strength and rigidity to the panel.

Drilling the acoustic skin is a long and costly operation. Indeed, the acoustic skin has of the order of 100 000 holes/m² of which the diameter is of the order of 1.5 mm, this drilling having to be performed with a drill bit on a “five axes” drilling machine, preferably with a multispindle head. Such a machine is very costly since, for each hole to be drilled on the surface of the shell sector of the panel, it must bring the drilling means into the required position with the desired orientation. Tooling is also costly since it must ensure that the acoustic skin is kept in the exact shape that it will have on the panel, that is to say by preventing it from deforming.

More efficient panels called “double resonator” acoustic panels are also known. These are sandwich structures comprising successively, in the thickness direction: a multiperforated acoustic skin, a first, “primary” honeycomb, a likewise multiperforated septum, a second, “secondary” honeycomb and a solid skin. The septum is an organic composite comprising 1 to 3 reinforcing fabric layers embedded in a resin hardened by curing. Unlike the skins, the septum is thin and flexible since it contributes little to the strength and rigidity of the panel, its function being consequently essentially acoustic. Production of the skins and septum, drilling the acoustic skin and the septum as well as assembly of the panel are carried out using techniques already described for a single resonator panel.

Also known, although rarely used since they are very costly, are acoustic panels comprising N>1 septa made into a sandwich between N+1 honeycombs, that is to say mainly what are called “triple resonator” panels comprising successively in the thickness direction: an acoustic skin, a primary honeycomb, a primary septum, a secondary honeycomb, a secondary septum, a tertiary honeycomb and finally a solid skin.

Drilling the septum is unfortunately an even longer and more costly operation than drilling the acoustic skin since the holes have at the present time a small diameter of the order of 0.3 mm and the septum has typically of the order of 800 000 holes/m², a typical 6 m² panel having consequently of the order of 8 000 000 (8×10⁶) holes to be drilled. At the present time, the septum is drilled in the same way as drilling the acoustic skin, but however using a laser beam instead of a drill bit. Thus the use on pods of acoustic panels with at least a double resonator, as a replacement for acoustic panels with a single resonator, involves a very high additional cost.

The problem to be solved is that of reducing the additional cost of making acoustic panels when they have at least one double resonator, as a replacement for panels with a single resonator.

### STATEMENT OF THE INVENTION

To solve this problem, the invention provides a method for making an acoustic panel with at least a double resonator, this panel comprising, in the thickness direction, at least the following layers in the following order: a multiperforated acoustic skin, a primary honeycomb, a likewise multiperforated septum, a secondary honeycomb and a solid skin, the septum being made into a sandwich between the two honeycombs, the panel being assembled by stacking and adhesive bonding the aforementioned constituents on a mold in the shape of the panel to be obtained, a transverse pressure being exerted on the constituents during bonding so as to press them against each other as well as against the mold.

Such a panel is noteworthy in that the septum is obtained during the assembly of the panel by positioning a plurality of component parts edge to edge against one of the honeycombs and by covering said component parts positioned in this way by the other honeycomb, these component parts being cut from a flexible strip, these component parts being defined so as to enable, with suitable flexing, an approximation of the final shape of the septum, assembled by developable curved surfaces substantially joined together, to be obtained, the maximum error being noted as E, the transverse pressure then bringing about the deformation of the component parts so as to bring them to the final shape of the septum, E having a sufficiently low value to prevent the component parts from creasing and tearing during this deformation.

It will be understood that the present invention profits from the fact that the septum contributes only to a very small extent to the strength of the panel. Thus the approximation of the shape of the septum by a plurality of developable elementary surfaces makes it possible to cut the component parts of the septum from the strip, that is to say from the material made of a thin flexible sheet, it being possible to drill the holes of the septum before assembly and advantageously flat. Drilling under these conditions is rapid and inexpensive since it can be carried out on a simple universal three-axes machine or on a specialized machine, automation being very much simplified in both cases.

At the start of transverse compression, approximation of the shape of the septum by the developable elementary surfaces makes it possible to flex the component parts without stresse so as to approach the shape of the septum to within the error E.

Continuing compression, the component parts take their final shape given by the mold, obviously taking into account the thickness of the layers present between mold and septum. This shaping however induces stresses in the component parts when the final shape of the septum is not developable since the relative distances between any geometric points on the component parts are likely to vary. The operator defines the component parts in order to limit the value of E and consequently the stresses generated in the component parts so as not to induce creasing or tearing thereof or even induce localized crushing of a honeycomb. The value of E is determined experimentally since it depends on many parameters, in particular on the actual shape of the panel, the properties of the material making up the septum and the orientation of the reinforcing fibers of which it consists. It should be noted that the material of the septum can flow during the thermal cycle of the assembly, which reduces the residual stresses existing in the septum after assembly. In practice, E can lie between 2 mm and 2.5 mm in the case of half-shells of the thrust reverser part of the pod.

Advantageously, the maximum error E has a value sufficient for the total surface area of the cells of each honeycomb situated entirely facing the component parts to be at least equal to 90% of the total surface area of the panel. It will in point of fact be understood that a space inevitably exists between the edges of two adjacent component parts, this space modifying the acoustic properties of the cells of the honeycomb that are situated in this space. In other words, only the cells that are completely over one component part and that therefore do not overlap this component part are effective in attenuating sound. A person skilled in the art will consequently give E the largest possible value compatible with the preceding constraints, so as to limit the number of component parts making up the septum and, consequently the fraction assigned to the surface of the panel.

Even more advantageously, the honeycomb positioned on the mold just before the septum has its surface in contact with the septum precoated with an adhesive having adhesive strength at the moment the component parts of the septum are applied to this honeycomb. The term “adhesive strength” is understood to mean that the adhesive is able immediately to hold, at least temporarily, the component parts applied to the honeycomb so as to hold the component parts in place during assembly.

Advantageously, this adhesive strength also enables the component parts to be lifted or moved as required with a limited force, so that the operator can precisely adjust the position of the component parts in relation to each other when they are placed on the honeycomb.

Even more advantageously:
a) a septum divided into component parts and the two honeycombs surrounding it are assembled together separately by stacking and adhesive bonding on a mold, the mold having a suitable shape to give the septum its final shape, obviously taking into account the layers positioned between the mold and the septum, a transverse pressure also being exerted on these constituents during gluing;
b) a check is then made of the degee of blocking of the holes of the septum by the adhesive;
c) the panel is then assembled, that is to say the remaining layers are put in place and bonded.

It will be understood that, following this intermediate assembly, the septum is accessible and visible from the outside through the cells of a honeycomb and this makes it possible to verify that the proportion of holes in the septum blocked by adhesive is indeed what was planned, the acoustic properties of the panel depending on this. Verification can be carried out optically or pneumatically. It will be understood that such a check is no longer possible after the panel has been completely assembled, since the cells surrounding the septum are covered by the skins.

The component parts making up the septum can be cut from an entirely preperforated strip or one preperforated only in the zones that will constitute these component parts. In a particular embodiment, the component parts are perforated after they are cut and prior to their assembly on a honeycomb.

### DESCRIPTION OF THE FIGURES

FIG. 1 shows the structure of the panel in a partial sectional view, as well as the mold.

FIG. 2 shows the shape of the acoustic panel and more particularly of the septum in the case of a reverser half-shell, as well as the definition of the component parts of the septum.

FIG. 3 shows the component parts of the septum cut from a strip.

FIG. 4 shows the approximation achieved for defining the component parts of the septum, the error between the final shape and the approximated developable shape having been enlarged for the sake of clarity.

### DETAILED DESCRIPTION

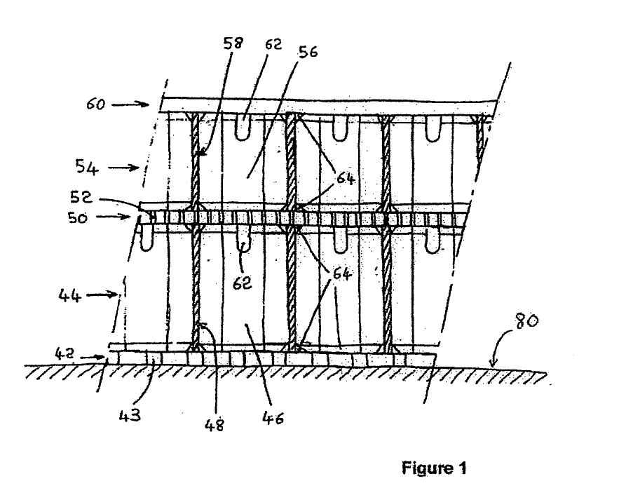

Reference will be made first of all to FIG. 1. The acoustic panel 40 is in this example one with a double resonator and has a laminated structure comprising successively, in the thickness direction, a first, acoustic perforated skin 42, a first, primary honeycomb 44, a micro perforated septum 50, a second, secondary honeycomb 54 and a solid skin 60.

The acoustic skin 42 is made of an organic composite consisting of three to ten layers of a Kevlar fiber or carbon fiber fabric embedded in an epoxy resin hardened by curing. The acoustic skin 42 is obviously in contact with the air 36 circulating in the vein 22 and a plurality of holes 43 pass through it having a diameter of 1.5 mm with a perforation density of the order of 100 000 holes/m².

The primary honeycomb 44 comprises cells 46 passing through it in the thickness direction, these cells 46 being separated by thin partitions 48 made generally of aluminum strip.

The septum 50 is made of an organic composite comprising from one to three layers of glass fiber fabric embedded in an epoxy resin hardened by curing. A plurality of holes 52 pass through the septum having a diameter of 0.3 mm with a perforation density of the order of 800 000 holes/m².

The secondary honeycomb 54 is similar to the primary honeycomb 44 and its cells and partitions will be referenced 56 and 58 respectively.

The solid skin 60 is similar to the acoustic skin 40 but does not include holes.

The various layers 42, 44, 50, 54 and 60 are held together by the adhesive 64.

The production of the acoustic skin 42 made of an organic composite material is conventional and comprises the following successive operations: molding, trimming, machining and drilling, these being well known to a person skilled in the art.

It will be remembered that molding briefly consists of superimposing layers of reinforcing fabric on a mold, the fabric being previously impregnated with epoxy resin, the mold being in the shape of the component part to be obtained, in this case the acoustic skin, and of subjecting the fabric layers to a thermal cycle under pressure in an autoclave so as simultaneously to press the fabric layers against the mold and to ensure hardening of the resin by curing. At the present time, fabrics are sold already pre-impregnated with curable resin. The component part obtained in this way is relatively rigid but is thin and capable of deforming by flexing.

The drilling operation is long and costly. The component part is positioned on a support which holds it spatially without it being able to deform, and drilling is carried out with a drill bit on a numerically controlled “five axes” machine, this type of machine being the only one to enable the drilling implement to be brought into the appropriate orientation at all points of the component part.

Production of the solid skin 60 comprises the operations of molding and trimming that have just been described for the production of the acoustic skin.

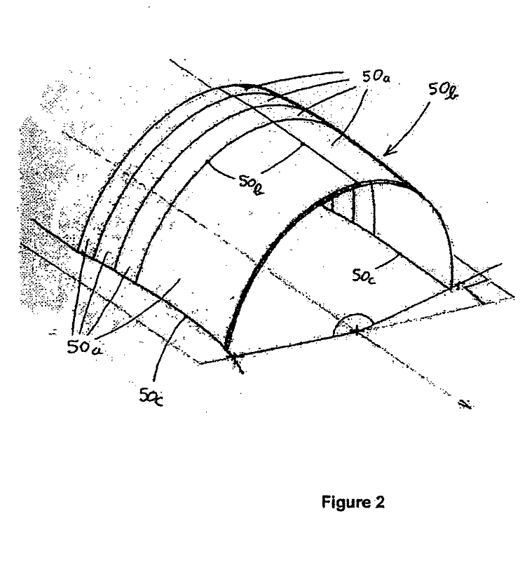

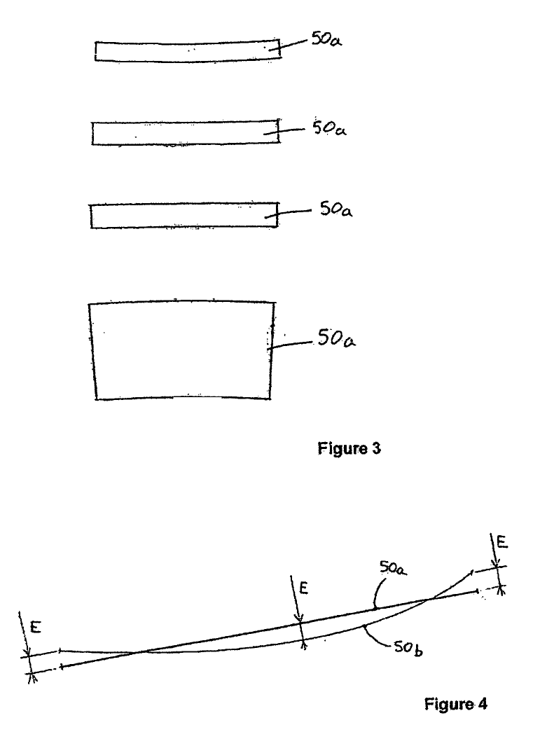

Reference will now be made to FIGS. 2 and 3. The different component parts 50a are cut from a strip made of organic composite material, the edge-to-edge assembly and shaping of these component parts enabling the septum 50 to be made. The component parts 50a are then positioned flat on a suitable flat table and the holes 52 of the septum 50 are drilled by laser beam using a single numerical control machine of the “three axes” type. The septum will advantageously be made of a composite material consisting of glass fiber fabric embedded in an epoxy resin, the glass fiber enabling the holes to be laser-drilled more cleanly.

Reference will now be made to FIGS. 1, 2 and 3. Assembly of the panel 40 comprises the following operations in which the adhesives employed are high-strength adhesives hardened by hot curing, that is to say:
1. Coating one face of the acoustic skin 42 with adhesive and putting this skin 42 in place on a mold 80, the adhesive-coated face being turned away from the mold 80, the mold 80 having the shape of the panel 40, that is to say a shape complementary to that of the outer face of the acoustic skin 42 after the panel 40 has been assembled.
2. Coating one face of the primary honeycomb 44 with adhesive and application of this primary honeycomb 44 onto the face of the acoustic skin 42 that is itself adhesive-coated, the adhesive-coated face of the primary honeycomb 44 being consequently turned away from the mold 80 and from the acoustic skin 42. The adhesive employed has adhesive properties at this stage, that is to say it is able to hold sufficiently light objects applied against it, in this case the component parts 50a of the septum 50. Coating can be carried out for example by applying a film of a suitable adhesive to this face and by exposing this adhesive film to a heat source, for example a flow of hot air or thermal radiation from heating elements. Under the effect of the heat bringing about crosslinking of the adhesive, the adhesive film tears and contracts so as to gel at the ends of the partitions 48 of the primary honeycomb 44.
3. Application to the adhesive-coated face of the primary honeycomb 44 of the various component parts-50a making up the septum 50, these component parts 50a being positioned edge to edge in their respective positions with just sufficient play so that, after the compression below, the edges of the component parts 50a come as closely as possible to each other without overlapping. The adhesive strength of the adhesive should advantageously allow the component parts 50a to be removed and put back in place so as to be able to position these component parts 50a precisely with respect to each other in order to reproduce the septum 50.
4. Coating one face of the secondary honeycomb 54 with adhesive and applying this secondary honeycomb 54 to the component parts 50a of the septum, the adhesive-coated face being against the component parts 50a of the septum 50 and consequently turned toward the mold 80. This bonding can be carried out for example in the same way as bonding of the primary honeycomb 44.
5. Coating one face of the solid skin 60 with adhesive and applying this solid skin 60 to the secondary honeycomb 54, the adhesive-coated face being against the secondary honeycomb 54 and consequently turned toward the mold 80.
6. The assembly prepared in this way is then put under transverse pressure, that is to say in the thickness direction, and subjected to a thermal cycle in an autoclave using standard bladder inflation techniques for molding laminated composites.

It should be noted that with some adhesives, bonding also includes a crosslinking operation.

The transverse pressure has the effect of pressing the various layers of the panel against each other and against the mold, with two results: that of giving the panel 40 its final shape during bonding and of allowing uniform bonding to take place over the entire surface of the panel. Transverse pressure also has the effect of deforming the component parts 50a between the primary honeycomb 44 and the secondary honeycomb 54, this deformation causing the septum to come into contact with the two surrounding honeycombs, this contact occurring substantially over the entire surface of the septum, and as a result giving the septum 50 produced in this way its final shape.

The thermal cycle has the effect of curing the adhesives and of finally bonding together the various layers constituting the panel 40.

Reference will now be made to FIGS. 2, 3 and 4. It is not critical to define the component parts 50a of the septum 50. Indeed, each component piece 50a is defined so as to permit, with suitable flexing, the approximation by a developable surface to the theoretical shape 50b of the septum, the maximum error being noted as E. Assembly of the component parts 50a placed end to end and flexed in a suitable manner thus makes it possible to constitute the shape of the complete septum 50 with this maximum error E.

The term “developable surface” is to be taken in a geometrical sense and signifies that this surface can be obtained by flexing a flat surface without changing the relative distances between any geometric points on this surface.

E should be sufficient to limit the number of component parts 50a and consequently the total length of the adjacent edges 50c of the component parts 50a. Indeed, a space inevitably exists between the adjacent edges of the component parts 50a, and the cells 46 that are located above these spaces will suffer reduced acoustic properties. It is therefore the unmodified surface area of the panel that is acoustically efficient, this surface area being the sum of the surface areas of the cells situated entirely facing a component part piece, that is to say not overlapping this component part piece.

In practice, a person skilled in the art will verify that this unmodified surface area is at least equal to 90% of the total surface area of the panel 40.

E should however remain limited so that the component parts 50a do not form creases and do not tear under the effect of the pressure exerted when the septum is glued with the two honeycombs. Indeed, this deformation is generally not simple flexing and the relative distances between any geometric points of the component parts are likely to vary. This is the case when the septum in its final shape is not itself a developable surface such as a sector of a cylinder or a frustum.

It should be noted that the residual stresses in the septum remain low since the composite material used is relatively flexible and is capable of partially flowing during the thermal cycle in an autoclave.

The method described above is given by way of example and can be the subject of alternative means of operating without departing from the scope of the invention or from its spirit. Accordingly:

The component parts 50a of the septum can be cut from the already completely drilled strip. This solution is fundamentally more costly since offcuts will also be drilled, but it can prove to be of value with a specialized machine.

The component parts 50a of the septum can also be cut from the strip drilled only in places where the component parts are to be cut out, so as exactly to save having to drill offcuts.

Assembly can be carried out in the reverse order, the solid skin being placed against the mold, the acoustic skin being outside. It should be noted however that the surface against the mold has a better surface condition than the surface opposite the mold.

Assembly can also be carried out in several steps, for example for the purpose of checking the degree of obstruction of the holes of the septum by the adhesive ensuring the bond between the septum and the two honeycombs.

The invention is also applicable to panels comprising N>1 multiperforated septa sandwiched between N+1 honeycombs, the assembly being itself sandwiched between an acoustic skin and a solid skin. This is for example the case for “triple resonator” panels comprising successively, in the thickness direction: a multiperforated acoustic skin, a first, “primary” honeycomb, a first, “primary” multiperforated septum, a second, “secondary” honeycomb, a second, “secondary” multiperforated septum, a third, “tertiary” honeycomb and finally a solid skin.

The panel is assembled as previously by stacking and adhesively bonding its constituents, it being possible for at least one septum to consist of elementary component parts cut from the strip, these component parts being then positioned on the honeycomb preceding the septum under consideration on the mold.

1. A method for making an acoustic panel with at least a double resonator, this panel comprising, in the thickness direction, in the following order at least the following layers: a multiperforated acoustic skin, a primary honeycomb, a likewise multiperforated septum, a secondary honeycomb and a solid skin, the septum being made into a sandwich between the two honeycombs, the panel being assembled by stacking and adhesive bonding the aforementioned constituents, on a mold in the shape of the panel to be obtained, a transverse pressure being exerted on the constituents during bonding so as to press them against each other as well as against the mold, the final shape of the septum in the assembled panel being referenced, characterized in that the septum is obtained during the assembly of the panel by positioning a plurality of component parts edge to edge against one of the honeycombs and by covering the component parts positioned in this way by the other honeycomb, the component parts being cut from a flexible strip, the component parts being defined so as to enable, with suitable flexing, an approximation of the final shape, by developable curved surfaces substantially joined together, to be obtained, the maximum error being noted as E, the transverse pressure then bringing about the deformation of the component parts so as to bring them to the final shape, E having a sufficiently low value to prevent the component parts from creasing and tearing during this deformation.

2. The method as claimed in claim 1, characterized in that the maximum error E has a sufficient value so that the total surface area of the cells of each honeycomb situated entirely facing the component parts is at least equal to 90% of the total surface area of the panel.

3. The method as claimed in claim 1, characterized in that the maximum error E is between 2 mm and 2.5 mm.

4. The method as claimed in claim 1, characterized in that the honeycomb positioned on the mold just before the septum has its surface in contact with the septum precoated with an adhesive having adhesive strength at the moment the component parts are applied to the honeycomb.

5. The method as claimed in claim 4, characterized in that the adhesive strength of the adhesive allows the component parts to be debonded and moved.

6. The method as claimed in claim 1, characterized in that:
a septum divided into component parts and the two honeycombs surrounding it are assembled together separately by stacking and adhesive bonding on a mold in the shape of the panel, a transverse pressure also being exerted on the constituents during bonding;
in that a check is then made of the degree of blocking of the holes of the septum by the adhesive;
and in that the panel is then assembled.

7. The method as claimed in claim 1, characterized in that the septum is cut from a preperforated strip.

8. The method as claimed in claim 7, characterized in that strip is preperforated in the zones constituting the component parts of the septum to be made.

9. The method as claimed in claim 1, characterized in that the component parts are perforated after they are cut from the strip and prior to their assembly on a honeycomb.

10. The method as claimed in claim 1, characterized in that the septum is produced with a composite material consisting of glass fiber fabric embedded in an epoxy resin.
